(19) United States
(12) Patent Application Publication
(10) Pub. No.: US 2024/0027225 A1
(43) Pub. Date: Jan. 25, 2024

(54) METHOD FOR UPDATING A DIGITAL MAP

(71) Applicant: Robert Bosch GmbH, Stuttgart (DE)

(72) Inventors: Andre-Marcel Hellmund, Hockenheim (DE); Carsten Hasberg, Ilsfeld-Auenstein (DE); Martin Lambertsen, Schellerten (DE); Muhammad Sheraz Khan, Heilbronn (DE); Tobias Strauss, Obersulm (DE); Michael Jung, Embrach (CH)

(21) Appl. No.: 18/256,482

(22) PCT Filed: Dec. 7, 2021
(86) PCT No.: PCT/EP2021/084500

§ 371 Date: Jun. 8, 2023

(30) Foreign Application Priority Data
Dec. 16, 2020 (DE) 10 2020 215 989.0

(51) Int. Cl. G01C 21/00

(52) U.S. Cl. CPC G01C 21/3841; G01C 21/3867

(57) ABSTRACT

A method for updating a digital map. The method includes: receiving motor vehicle data signals representing respective motor vehicle data of a plurality of motor vehicles, and updating in parallel a plurality of spatially separated map segments of the digital map based on the motor vehicle data in order to update the digital map. A device, a computer program, and a machine-readable storage medium, are also described.

### FIELD

The present invention relates to a method for updating a digital map. The present invention relates to a device, a computer program and a machine-readable storage medium.

### BACKGROUND INFORMATION

German Patent Application No. DE 10 2012 212 740 A1 describes a system and method for updating a digital map of a driver assistance system.

German Patent Application No. DE 10 2015 222 962 A1 describes a method for aggregating lane information for digital map services.

German Patent Application No. DE 10 2017 222 496 A1 describes a method for updating a digital navigation map.

### SUMMARY

An object of the present invention is to efficiently update a digital map.

This object may be achieved by the features of the present invention. Advantageous embodiments of the present invention are disclosed herein.

According to a first aspect of the present invention, a method for updating a digital map is provided. According to an example embodiment of the present invention, the method includes the following steps:

receiving motor vehicle data signals representing respective motor vehicle data of a plurality of motor vehicles, updating in parallel a plurality of spatially separated map segments of the digital map based on the motor vehicle data in order to update the digital map.

According to a second aspect of the present invention, a device is provided, which is configured to carry out all steps of the method according to the first aspect.

According to a third aspect of the present invention, a computer program is provided, which comprises instructions that, when the computer program is executed by a computer, for example by the device according to the second aspect, cause said computer to carry out a method according to the first aspect.

According to a fourth aspect of the present invention, a machine-readable storage medium is provided, on which the computer program according to the third aspect is stored.

The present invention is based on and includes the insight that the above object can be solved by updating a plurality of spatially separated map segments in parallel. Parallel within the meaning of the description means at the same time, so that the digital map can be updated faster than when updated not in parallel, i.e., if the map segments were to be updated one after the other.

This in particular produces the technical advantage that a digital map can be updated efficiently.

According to one example embodiment of the present invention, it is provided that a respective transition region directly adjoining a respective boundary of the plurality of map segments and enclosing the respective map segment is defined, wherein the parallel updating comprises adapting the respective transition region to the respective updated map segment such that the respective updated map segment is consistent with an environment of the transition region.

This, for example, may produce a technical advantage that a digital map can efficiently be updated in parallel. This can in particular advantageously efficiently ensure that the updated map segment is consistent with the rest of the digital map.

Within the meaning of the description, the phrase “directly surrounded” means that the further map segments directly adjoin the respective updated map segment, i.e., there is no other map segment between a further map segment and the updated map segment.

Consistent within the meaning of the description means, for example, that the aligned motor vehicle trajectories required for mapping and/or the map itself are continuous at the transitions, i.e., in particular have no jumps and/or no kinks and/or no abrupt change of curvature, etc.

In one embodiment of the present invention, it is provided that adapting the respective transition region to the respective updated map segment is carried out using a consistency metric.

This, for example, may produce a technical advantage that the adaptation can be carried out efficiently. The stress introduced by a new trajectory (deviation between the aligned trajectory or trajectories and the respective associated measurements (odometry, global position)) can be used as a consistency metric, for example. The purpose of the transition region is in particular to reduce these stresses. Readjustment is in particular carried out only in the transition region and in particular not in the map enclosing the transition region.

In one embodiment of the present invention, it is provided that a size and/or a shape, in particular a spatial or topological extent, of the transition region is ascertained on the basis of the consistency metric.

This, for example, may produce a technical advantage that the size and/or shape of the transition region can be ascertained efficiently. This in particular produces the technical advantage that a transition region suitable for the specific map segments to be updated can be ascertained.

A transition region can thus be formed as a polygon, for example, in particular a rectangle, that completely encloses the map segment to be updated. A transition region can be formed as a topological extension of the graph, for instance. A topological extension is in particular understood to mean that all roads at the edges are or have been extended by a specific distance, for example to be able to reach all parts that are within a road kilometer (as opposed to as the crow flies).

According to one example embodiment of the present invention, it is provided that a respective motor vehicle trajectory of the motor vehicles is ascertained on the basis of the motor vehicle data, wherein the respective ascertained motor vehicle trajectories are aligned with the digital map, wherein aligning the respective ascertained motor vehicle trajectories and updating in parallel a plurality of spatially separated map segments in overlapping geographic regions of the digital map is carried out one after the other, such that the alignment of the respective ascertained motor vehicle trajectories is not carried out during the parallel updating of a plurality of spatially separated map segments.

This, for example, produces the technical advantage that the motor vehicle trajectories can be aligned efficiently and that the map segments can be efficiently updated in parallel without encountering problems in overlapping geographic regions.

According to one example embodiment of the present invention, it is provided that the updating in parallel comprises recreating a map segment and/or updating the recreated map segment.

This, for example, may produce the technical advantage that the map segment can be recreated efficiently or that a recreated map segment can be updated efficiently.

According to one example embodiment of the present invention, motor vehicle data within the meaning of the description include one or more of the following data, for example: environmental data, speed data, position data, sensor data, in particular surroundings sensor data of a surroundings sensor of the motor vehicle representing a surroundings of the motor vehicle, surroundings data representing a surroundings of the motor vehicle, in particular a digital model of the surroundings.

A surroundings sensor is one of the following surroundings sensors, for instance: radar sensor, LiDAR sensor, video sensor, infrared sensor, magnetic field sensor and ultrasonic sensor.

According to one example embodiment of the present invention, the method according to the first aspect is a computer-implemented method.

Technical functionalities of the method according to the first aspect result analogously from corresponding technical functionalities of the device according to the second aspect and vice versa.

This means that device features result from corresponding method features and vice versa.

Embodiment examples of the present invention are shown in the figures and explained in more detail in the following description.

### BRIEF DESCRIPTION OF THE DRAWINGS

FIG. 1 shows a flowchart of a method for updating a digital map, according to an example embodiment of the present invention.

FIG. 2 shows a device according to an example embodiment of the present invention.

FIG. 3 shows a machine-readable storage medium, according to an example embodiment of the present invention.

FIG. 4 shows a digital map, according to an example embodiment of the present invention.

### DETAILED DESCRIPTION OF EXAMPLE EMBODIMENTS

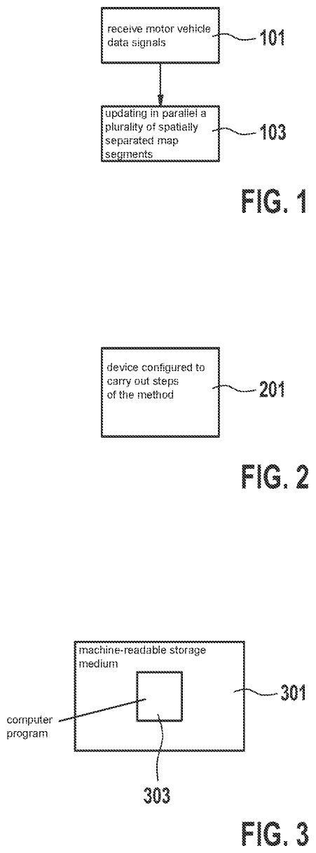

FIG. 1 shows a flowchart of a method for updating a digital map, comprising the following steps:
receiving 101 motor vehicle data signals representing respective motor vehicle data of a plurality of motor vehicles,
updating 103 in parallel a plurality of spatially separated map segments of the digital map based on the motor vehicle data in order to update the digital map.

FIG. 2 shows a device 201. The device 201 is configured to carry out all steps of the method according to the first aspect.

FIG. 3 shows a machine-readable storage medium 301. A computer program 303 is stored on the machine-readable storage medium 301. The computer program 303 comprises instructions that, when the computer program 303 is executed, for example by the device 201 of FIG. 2, prompt said computer to carry out a method according to the first aspect.

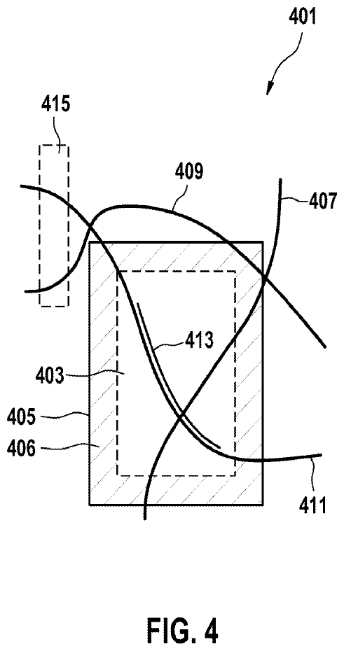

FIG. 4 shows a digital map 401.

The digital map 401 comprises a first map segment 403. A box or a frame 405 which completely encloses the first map segment 403 is defined or specified or placed around the first map segment 403. Thus a transition region 406, depicted with cross-hatching, is specified or defined between the first map segment 403 and the box 405.

The digital map 401 further includes a first road 407, a second road 409 and a third road 411. The first road 407 and the third road 411 extend in part in the first map segment 403. The second road 409 extends outside the first map segment 403, but partly inside the transition region 406.

A motor vehicle trajectory 413 which extends inside the first map segment 403 is also drawn in.

A second map segment 415 of the digital map is shown as well. The two map segments 403, 415 are spatially separated from one another.

According to one embodiment, it is provided that the two map segments 403, 415 are updated in parallel.

According to one embodiment, updating in parallel includes adapting the transition region 406 to the updated first map segment 403 such that the updated first map segment 403 is consistent with an environment of the second map segment 415. In principle, consistent with the environment means in particular being consistent at the frame 405 or the previously undefined frame around the transition region 406 around the map segment 415.

In one embodiment, it is provided that the motor vehicle trajectory 413 is aligned with a travel lane (not depicted) of the third road 411.

In one embodiment, the map segments are not predefined, but are instead respecified each time new data is processed.

1.-9. (canceled)

10. A method for updating a digital map, comprising the following steps:
receiving motor vehicle data signals representing respective motor vehicle data of a plurality of motor vehicles; and
updating in parallel a plurality of spatially separated map segments of the digital map based on the motor vehicle data in order to update the digital map.

11. The method according to claim 10, wherein a respective transition region directly adjoining a respective boundary of the plurality of map segments and enclosing a respective map segment is defined, wherein the parallel updating includes adapting the respective transition region to the respective updated map segment such that the respective updated map segment is consistent with an environment of the transition region.

12. The method according to claim 11, wherein the adapting of the respective transition region to the respective updated map segment is carried out using a consistency metric.

13. The method according to claim 12, wherein a size and/or a shape of the transition region is ascertained based on the consistency metric.

14. The method according to claim 10, wherein a respective motor vehicle trajectory of each of the motor vehicles is ascertained based on the motor vehicle data, wherein the respective ascertained motor vehicle trajectories are aligned with the digital map, wherein aligning the respective ascertained motor vehicle trajectories and updating in parallel a plurality of spatially separated map segments in overlapping geographic regions of the digital map is carried out one after the other, such that the alignment of the respective ascertained motor vehicle trajectories is not carried out during the parallel updating of a plurality of spatially separated map segments.

15. The method according to claim 10, wherein the updating in parallel includes recreating a map segment and/or updating the recreated map segment.

16. A device configured to update a digital map, the device configured to:
receive motor vehicle data signals representing respective motor vehicle data of a plurality of motor vehicles; and
update in parallel a plurality of spatially separated map segments of the digital map based on the motor vehicle data in order to update the digital map.

17. A non-transitory machine-readable storage medium on which is stored a computer program for updating a digital map, the computer program, when executed by a computer, causing the computer to perform the following steps:
receiving motor vehicle data signals representing respective motor vehicle data of a plurality of motor vehicles; and
updating in parallel a plurality of spatially separated map segments of the digital map based on the motor vehicle data in order to update the digital map.
